(19) United States
(12) Patent Application Publication
(10) Pub. No.: US 2016/0363041 A1
(43) Pub. Date: Dec. 15, 2016

(54) Combustion Pre-Chamber Assembly Including Fluidic Oscillator

(71) Applicant: Caterpillar Inc., Peoria, IL (US)

(72) Inventors: Robert J. Moffat, Los Altos, CA (US); Martin L. Willi, Dunlap, IL (US)

(73) Assignee: Caterpillar Inc., Peoria, IL (US)

(21) Appl. No.: 14/739,464

(22) Filed: Jun. 15, 2015

(51) Int. Cl. F02B 19/10; F02F 7/00; F02F 1/24; F02B 19/12; F02B 19/18

(52) U.S. Cl. CPC F02B 19/108; F02B 19/12; F02B 19/18; F02B 19/1004; F02F 1/24; F02F 7/0002

(57) ABSTRACT

A combustion pre-chamber assembly for a reciprocating internal combustion engine includes a body that defines a combustion pre-chamber, a plurality of orifices that extend through the body and effect fluid communication between the combustion pre-chamber and a main combustion chamber of the reciprocating internal combustion engine, a fuel inlet conduit, and a fluidic oscillator flow path with an oscillator inlet in fluid communication with an outlet of the fuel inlet conduit, and an oscillator outlet in fluid communication with the combustion pre-chamber. An ignition device is operatively coupled to the combustion pre-chamber. The fluidic oscillator flow path includes a plurality of oscillator conduits fluidly coupled to one another in parallel. Each oscillator conduit effects fluid communication between the oscillator inlet and the oscillator outlet.

### TECHNICAL FIELD

This patent disclosure relates generally to reciprocating internal combustion engines and, more particularly, to a combustion pre-chamber assembly for an internal combustion engine and a method for operating the same.

### BACKGROUND

Reciprocating internal combustion (IC) engines are known for converting chemical energy from a fuel supply into mechanical shaft power. A fuel-oxidizer mixture is received in a variable volume of an IC engine defined by a piston translating within a cylinder bore. The fuel-oxidizer mixture burns inside the variable volume to convert chemical energy in the mixture into heat. In turn, expansion of the combustion products within the variable volume performs work on the piston, which may be transferred to an output shaft of the IC engine.

Some constituents in the exhaust stream from an IC engine, such as, for example, nitrogen oxides (NOx), unburned hydrocarbons (UHCs), and particulate matter (PM), may be subject to government regulations. Accordingly, operators may wish to control concentrations of regulated exhaust constituents released to the environment. The composition of exhaust discharged from an IC engine may be affected by control of the combustion process within the variable volume combustion chamber, exhaust aftertreatment downstream of the combustion chamber, or combinations thereof.

Some IC engines employ an externally-powered ignition source to initiate combustion of the fuel-oxidizer mixture within the variable volume. For example, an IC engine may include an ignition device, such as a spark plug which defines a gap between electrodes, where the gap is in fluid communication with the variable volume and in electrical communication with an electric potential. Accordingly, applying the electric potential across the gap may cause an electric spark to arc across the gap, thereby initiating combustion of the fuel-oxidizer mixture within the variable volume.

European Publication No. 2700796 A1 (“the '796 publication”), entitled “Pre-combustion Chamber of an Internal Combustion Engine and Method of Operating the Same,” is directed toward an assembly that is positioned within a cylinder head of an engine and includes a chamber that may be supplied with a gaseous fuel by a fuel supply connection. The gaseous fuel supplied may combine with a fluid mixture in the chamber and a spark plug of the '796 publication may ignite a gaseous mixture in the chamber and create a front of burning fuel. The front of burning fuel may be conveyed through orifices provided in a tip of the assembly and into a main combustion chamber of the '796 publication, and may ignite a mixture of fluids within the main combustion chamber. The orifices are described in the '796 publication as being configured to reduce a thermal stress applied to the tip. However, the '796 publication does not provide guidance regarding a degree to which the gaseous fuel supplied from the fuel supply connection is mixed with the fluid mixture in the chamber, which may affect an amount of fuel within the combined mixture that is ignited and an efficiency of a combustion process.

These and other shortcomings of the prior art are addressed by the present disclosure.

### SUMMARY

A combustion pre-chamber assembly for a reciprocating internal combustion engine includes a body that defines a combustion pre-chamber, a plurality of orifices that extend through the body and effect fluid communication between the combustion pre-chamber and a main combustion chamber of the reciprocating internal combustion engine, a fuel inlet conduit, and a fluidic oscillator flow path with an oscillator inlet in fluid communication with an outlet of the fuel inlet conduit, and an oscillator outlet in fluid communication with the combustion pre-chamber. An ignition device is operatively coupled to the combustion pre-chamber. The fluidic oscillator flow path includes a plurality of oscillator conduits fluidly coupled to one another in parallel. Each oscillator conduit effects fluid communication between the oscillator inlet and the oscillator outlet.

According to another aspect of the present disclosure, a reciprocating internal combustion engine, comprises a cylinder block, a cylinder positioned within the cylinder block and defining a main combustion chamber, a cylinder head attached to the cylinder, a combustion pre-chamber assembly positioned within the cylinder head in fluid communication with the main combustion chamber, an intake duct configured to supply a first flow of fuel and a flow of oxidizer to the main combustion chamber, and a fuel supply system configured to supply a second flow of fuel to the combustion pre-chamber assembly. The combustion pre-chamber assembly may include a body and an ignition device operatively coupled to combustion pre-chamber defined by the body. The body of the combustion pre-chamber assembly may further define a plurality of orifices that extend through the body and effect fluid communication between the combustion pre-chamber and the main combustion chamber of the reciprocating internal combustion engine, a fuel inlet conduit, and a fluidic oscillator flow path with an oscillator inlet in fluid communication with an outlet of the fuel inlet conduit, and with an oscillator outlet in fluid communication with the combustion pre-chamber. The fluidic oscillator flow path may include a plurality of oscillator conduits fluidly coupled to one another in parallel such that each oscillator conduit of the plurality of oscillator conduits effects fluid communication between the oscillator inlet and the oscillator outlet.

An aspect of the present disclosure provides a method for providing an ignition energy to a main combustion chamber of an internal combustion engine via a combustion pre-chamber assembly disposed in fluid communication with the main combustion chamber. The method may comprise supplying a first flow of fuel and a flow of oxidizer via the main combustion chamber into a combustion pre-chamber defined by the combustion pre-chamber assembly; supplying a second flow of fuel to an oscillator inlet of a fluidic oscillator flow path including a plurality of oscillator conduits fluidly coupled to one another in parallel such that each oscillator conduit of the plurality of oscillator conduits effects fluid communication between the oscillator inlet and the oscillator outlet; passively inducing a periodic modulation of the second flow of fuel exiting the oscillator outlet; forming a mixture of the second flow of fuel, the first flow of fuel, and the flow of oxidizer within the combustion pre-chamber; supplying the ignition energy to the combustion pre-chamber and igniting the mixture in the combustion pre-chamber to produce combustion products; and flowing the combustion products from the combustion pre-chamber via a plurality of orifices defined by the combustion pre-chamber to provide the main combustion chamber with the ignition energy.

### BRIEF DESCRIPTION OF THE DRAWINGS

FIG. 1 illustrates a schematic view of an IC engine, according to an aspect of the present disclosure.

FIG. 2 illustrates a front cross sectional view of a cylinder head including a combustion pre-chamber assembly, according to an aspect of the present disclosure.

FIG. 3 illustrates an enlarged portion of FIG. 2, identified as Detail 3.

FIGS. 4A and 4B illustrate an enlarged portion of FIG. 3, identified at Detail 4.

FIGS. 5A-C illustrate an enlarged portion of FIG. 3, identified as Detail 5.

FIG. 6 illustrates an isometric view of a sub-assembly of the combustion pre-chamber assembly of FIG. 2, according to an aspect of the present disclosure.

FIG. 7 illustrates a top cross sectional view of the sub-assembly of FIG. 6, taken along section line 7-7.

FIG. 8 illustrates a top cross sectional view of the sub-assembly of FIG. 6, taken along section line 7-7, modified according to one aspect of the present disclosure.

FIG. 9 illustrates a front cross sectional view of a combustion pre-chamber assembly, according to an aspect of the present disclosure.

FIG. 10 illustrates a top cross sectional view of the second housing of FIG. 9, taken along a section line 10-10.

FIG. 11 illustrates a front cross sectional view of a combustion pre-chamber assembly, according to an aspect of the present disclosure.

FIG. 12 illustrates a front cross sectional view of a combustion pre-chamber assembly, according to an aspect of the present disclosure.

FIG. 13 illustrates a front cross sectional view of a combustion pre-chamber assembly, according to an aspect of the present disclosure.

FIG. 14 illustrates an exploded view of the combustion pre-chamber assembly of FIG. 2, according to an aspect of the present disclosure.

### DETAILED DESCRIPTION

Aspects of the disclosure will now be described in detail with reference to the drawings, wherein like reference numbers refer to like elements throughout, unless specified otherwise.

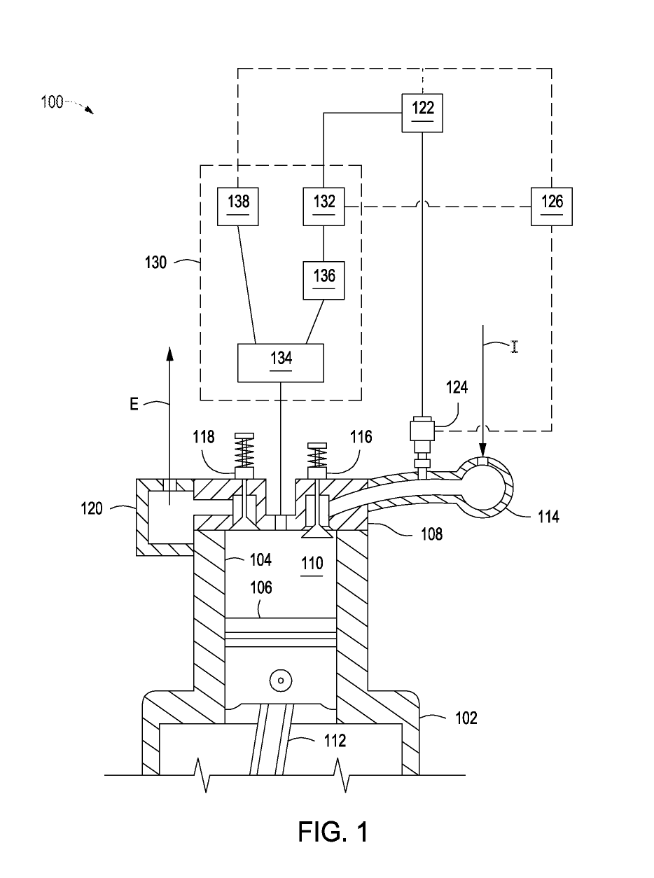

FIG. 1 illustrates a schematic view of an IC engine 100, according to an aspect of the present disclosure. The IC engine 100 may be a reciprocating internal combustion engine, such as a spark ignition engine, a compression ignition engine, or, as one skilled in the art will recognize, any other reciprocating internal combustion engine known in the art that would utilize a combustion pre-chamber. The IC engine 100 may be of any size, with any number of cylinders, and in any configuration (“V,” in-line, radial, etc.). For the purposes of the present disclosure, the IC engine 100 is considered a 4-stroke gaseous fueled engine, however, the IC engine 100 may operate on any cycle, such as a 2-stroke cycle, an Otto cycle, a Miller Cycle, a homogeneous charge compression ignition cycle, a reactivity controlled compression cycle ignition, combinations thereof, or any other internal combustion cycle known in the art. The IC engine 100 may be a “lean-burn” engine that at least temporarily operates under lean conditions in which the fuel/oxidizer ratio is less than the stoichiometric fuel-to-oxidizer ratio, and the IC engine 100 may be configured to burn one or more types of fuels including gasoline, diesel fuel, natural gas, combinations thereof, or any other combustible fuel known in the art. Furthermore, the IC engine 100 may include features not shown, such as fuel systems, air systems, cooling systems, peripheries, drivetrain components, turbochargers, combinations thereof, or any other engine system known in the art.

An actual fuel/oxidizer ratio may be normalized by the stoichiometric fuel-to-oxidizer ratio to yield an equivalence ratio. As used herein, unless specified otherwise, a mixture having an equivalence ratio less than one is fuel lean and will result in excess oxygen and no unburned fuel upon complete combustion, and a mixture having an equivalence ratio greater than one is fuel rich and will result in unburned fuel and no excess oxygen upon complete combustion.

The IC engine 100 may be used to power any machine or other device, including locomotive applications, on-highway trucks or vehicles, off-highway trucks or machines, earth moving equipment, stationary power generators, pipelines, gas storage applications, aerospace applications, marine applications, pumps, stationary equipment, or other engine-powered applications.

The IC engine 100 includes a block 102 defining at least one cylinder bore 104 therein, at least one piston 106 disposed in sliding engagement with the cylinder bore 104, and a cylinder head 108 disposed on the block 102. The cylinder bore 104, the piston 106, and the cylinder head 108 define a main combustion chamber 110. A volume of the main combustion chamber 110 may vary with the location of the piston 106 relative to the cylinder head 108, such that the volume of the main combustion chamber 110 is at a maximum when the piston 106 is located at Bottom Dead Center (BDC) of its stroke, and the volume of the main combustion chamber 110 is at a minimum when the piston 106 is located at Top Dead Center (TDC) of its stroke.

The IC engine 100 may operate according to a four-stroke cycle, including an intake stroke (TDC to BDC), a compression stroke (BDC to TDC), an expansion stroke (TDC to BDC), and an exhaust stroke (BDC to TDC). Alternatively, the IC engine 100 may operate according to a two-stroke cycle, including a compression/exhaust stroke (BDC to TDC) and an expansion/exhaust/intake stroke (TDC to BDC).

The piston 106 is pivotally connected to a crankshaft (not shown) via a connecting rod 112 for transmitting mechanical power therebetween. Although only one piston 106 and cylinder bore 104 are shown in FIG. 1, it will be appreciated that the IC engine 100 may be configured to include any number of cylinder bores 104 and pistons 106 to suit a particular design or application.

The IC engine 100 receives a flow of oxidizer (I) from an intake duct 114. An intake valve 116 may operate to provide selective fluid communication between the intake duct 114 and the main combustion chamber 110. More than one intake valve 116 may be provided. The IC engine 100 discharges a flow of exhaust (E) to an exhaust duct 120. An exhaust valve 118 may operate to provide selective fluid communication between the main combustion chamber 110 and the exhaust duct 120. More than one exhaust valve 118 may be provided. The intake valve 116 and the exhaust valve 118 may be actuated by a cam/push-rod/rocker arm assembly (not shown), a solenoid actuator, a hydraulic actuator, or by any other cylinder valve actuator known in the art to open or close intake and exhaust valves.

The IC engine 100 receives combustible fuel from a fuel supply system 122. The fuel supply system 122 may include fuel storage, compressors, pumps, valves, regulators, instrumentation, or any other elements known in the art to be useful for supplying a flow of fuel. A main fuel injector 124 may receive a flow of fuel from the fuel supply system 122 and be disposed in fluid communication with the intake duct 114 upstream of the intake valve 116. Alternatively, the main fuel injector 124 may be disposed in direct fluid communication with the main combustion chamber 110. The main fuel injector 124 may be operatively connected to a controller 126, which may be configured to operate the main fuel injector 124 and change a configuration of fluid communication between the fuel supply system 122 and the main combustion chamber 110 via the main fuel injector 124. For example, the controller 126 may operate the main fuel injector 124 to provide or block fluid communication between the fuel supply system 122 and the main combustion chamber 110 via the main fuel injector 124.

The IC engine 100 includes a combustion pre-chamber assembly 130 in fluid communication with the main combustion chamber 110. The combustion pre-chamber assembly 130 includes a pre-chamber fuel injector 132 in fluid communication with fuel supply system 122. As illustrated schematically in FIG. 1, the pre-chamber fuel injector 132 is also in fluid communication with a combustion pre-chamber 134 (hereafter referred to as “pre-chamber 134”) through a fluidic oscillator 136 which is located upstream of the pre-chamber 134. The pre-chamber fuel injector 132 may be operatively connected to the controller 126, which may be configured to selectively operate the pre-chamber fuel injector 132 to change a configuration of fluid communication between the fuel supply system 122 and the main combustion chamber 110 via the combustion pre-chamber assembly 130. For example, the controller 126 may operate the pre-chamber fuel injector 132 to provide or block fluid communication between the fuel supply system 122 and the main combustion chamber 110 via the combustion pre-chamber assembly 130.

Each of the main fuel injector 124 and the pre-chamber fuel injector 132 may include an actuator operatively connected to the controller 126. The actuator for either of the main fuel injector 124 and the pre-chamber fuel injector 132 may include a solenoid actuator, a hydraulic actuator, a pneumatic actuator, a mechanical actuator, such as, for example a cam actuator, combinations thereof, or any other fuel injector actuator known in the art. As such, the controller 126 may control an amount of fuel delivered to the main combustion chamber 110 by controlling an opening time duration, an effective flow area, or combinations thereof, for each of the main fuel injector 124 and the pre-chamber fuel injector 132.

The fuel supply system 122 may include sources of different combustible fuels. According to one aspect of the disclosure, the fuel supply system 122 is configured to provide a first fuel to the combustion pre-chamber assembly 130, and a second fuel to the main combustion chamber 110, where the first fuel differs from the second fuel in at least one of supply pressure, matter phase, and chemical composition. Alternatively, the fuel supply system 122 may be configured to deliver the same fuel to each of the combustion pre-chamber assembly 130 and the main combustion chamber 110. The fuel supply system 122 may be configured to deliver a liquid fuel, a gaseous fuel, or combinations thereof.

The pre-chamber 134 is in fluid communication with the main combustion chamber 110. In particular, fluid(s) may be conveyed from the pre-chamber 134 to the main combustion chamber 110, and vice versa, according to an operation of the IC engine 100 described in further detail below. The pre-chamber 134 may be positioned adjacent the cylinder head 108, and may have a smaller volume as compared to the main combustion chamber 110, for example, when the piston 106 is located at BDC. According to an aspect of the disclosure, fuel delivered to the pre-chamber 134 is less than about 3% of the total fuel delivered to the main combustion chamber 110 during the same combustion cycle. Alternative engine arrangements may further include an exhaust gas re-circulation system (EGR) to re-circulate exhaust by-products to the intake duct 114 and/or the pre-chamber 134.

According to one aspect of the present disclosure, the IC engine 100 is a spark-ignited internal combustion. As discussed in more detail below, the IC engine 100 may be provided with an ignition energy during operation by an ignition device 138 disposed within the combustion pre-chamber assembly 130. The ignition device 138 may be operatively coupled to the controller 126 for control thereof. As one of ordinary skill will recognize, the ignition device 138 may be any suitable device that can provide an ignition energy pulse. In particular, the ignition device 138 may be any device which can provide an ignition energy in the form of a pulse of energy or a series of pulses of energy which may include a spark arcing across a gap of a spark plug, a pulse of laser light, or any other ignition energy pulse known in the art.

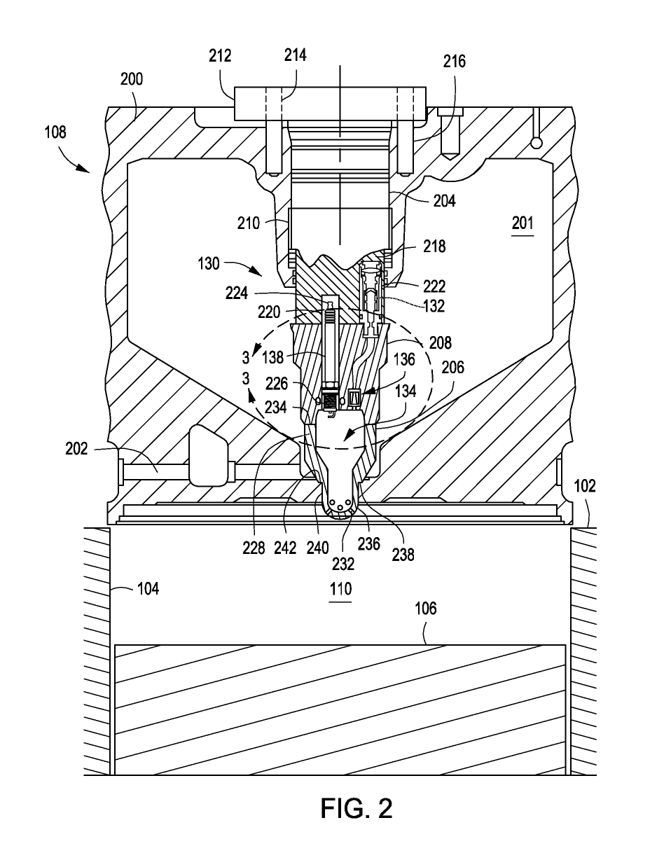

FIG. 2 illustrates a front cross sectional view of a cylinder head 108 including a combustion pre-chamber assembly 130, according to an aspect of the present disclosure. The combustion pre-chamber assembly 130 is positioned within a main fluid passage 201 defined within a cylinder head body 200 of the cylinder head 108. As described in more detail below, a fluid delivery conduit 202 defined by the cylinder head body 200 of the cylinder head 108 supplies fluid to the main fluid passage 201 to cool the combustion pre-chamber assembly 130, which is positioned between intake and exhaust valves (not shown). However, one skilled in the art will recognize that the combustion pre-chamber assembly 130 may be configured in a variety of ways. Other arrangements may be used to incorporate the combustion pre-chamber assembly 130 into the cylinder head 108 in order to support a combustion event outside of the main combustion chamber 110 when the ignition energy is provided, and to direct combustion products into the main combustion chamber 110.

The combustion pre-chamber assembly 130 may include a first housing 204, a tip 206, and a second housing 208 attached to the first housing 204 and the tip 206 there between. Alternatively, the combustion pre-chamber assembly 130 may be formed by more or less than three housings (including the tip).

The first housing 204 may extend through a first cylinder bore 210 defined by the cylinder head body 200 of the cylinder head 108 and be mounted to the cylinder head 108 with a flange 212. The flange 212 may include a pair of apertures 214 to receive fasteners 216 that couple the combustion pre-chamber assembly 130 to the cylinder head 108. The fasteners 216 prevent rotary and axial movement relative to the first cylinder bore 210. Alternatively, the first housing 204 may be attached to the cylinder head 108 via another fastening mechanism, for example, a threaded connection.

The first housing 204 includes a first housing body 218 and internal surfaces of the first housing body 218 may define a first housing ignition bore 220 and a first housing injector bore 222. The first housing ignition bore 220 may receive a portion of the ignition device 138 including an energy input end 224 (e.g. a terminal end), and that portion of ignition device 138 that is not positioned in the second housing 208 and the tip 206. The energy input end 224 may be provided on an opposite end of the ignition device 138 from ignition end 226 which is disposed in the second housing 208. The first housing injector bore 222 receives a portion of the pre-chamber fuel injector 132 that is not positioned in the second housing 208. The first housing 204 may be generally cylindrical and may be made from any suitable material. For example, the first housing 204 may be made of a ductile iron casting, including pearlitic ferritic iron, for example. The first housing 204 may be connected to the second housing 208 by a brazing material of a suitable composition capable of withstanding the environment (temperature, chemical, and mechanical loading) in which it is exposed. A silver-nickel braze material may be suitable for such an application.

The tip 206 includes a tip body 228, and internal surfaces of the tip body 228 may define a first portion of the pre-chamber 134 and a plurality of orifices 232. The pre-chamber 134 may generally have the same shape as that of the tip 206, and may open at a first end 234 of the tip 206 to receive the ignition end 226 (e.g. an end including an anode, a cathode, and a gap defined between the anode and the cathode) of the ignition device 138. The shape of the pre-chamber 134 is not limited by the shape of the tip 206 and may be formed to have surfaces of various contours which may promote the mixing of a fuel with an oxidizer within the pre-chamber 134.

The pre-chamber 134 is in fluid communication with the main combustion chamber 110 of the IC engine 100 via the plurality of orifices 232, which are defined by the tip body 228 at a second end 236 of the tip 206. The plurality of orifices 232 are arranged in a spaced apart configuration, however, the plurality of orifices 232 may be arranged in other configurations, including axial arrays of orifices along a longitudinal axis of the tip 206, circumferential arrays of orifices about the longitudinal axis of the tip, or combinations thereof. The second end 236 of the tip 206 extends through a second cylinder bore 240 defined by the cylinder head body 200 of the cylinder head 108 which opens into the main combustion chamber 110 and receives the second end 236 of the tip 206. The second cylinder bore 240 enables the second end 236 to extend into and be exposed to the main combustion chamber 110. In other arrangements, the second end 236 of the tip 206 may extend through the second cylinder bore 240 and be flush with a surface of the cylinder head 108 or the block 102. The tip body 228 defines the second end 236 of tip 206 to extend axially from a sealing surface 238 of the tip 206 which abuts a sealing surface 242 provided in the cylinder head 108 to prevent fluid supplied through the fluid delivery conduit 202 from leaking into the main combustion chamber 110.

The tip 206 is made from a high temperature material. For example, a high temperature, thermally stable, and environmentally resistant alloy, such as, a nickel-chromium-tungsten-molybdenum alloy is suitable. It is to be understood that other high temperature materials of suitable composition may be used for constructing the tip 206. The tip 206 may be generally cylindrical, and the first end 234 of the tip 206 may be connected to the second housing 208 by any suitable means, such as a brazing or welding. For example, a controlled depth penetration weld, such as, a laser or electron beam weld may be used to connect the tip 206 to the second housing 208.

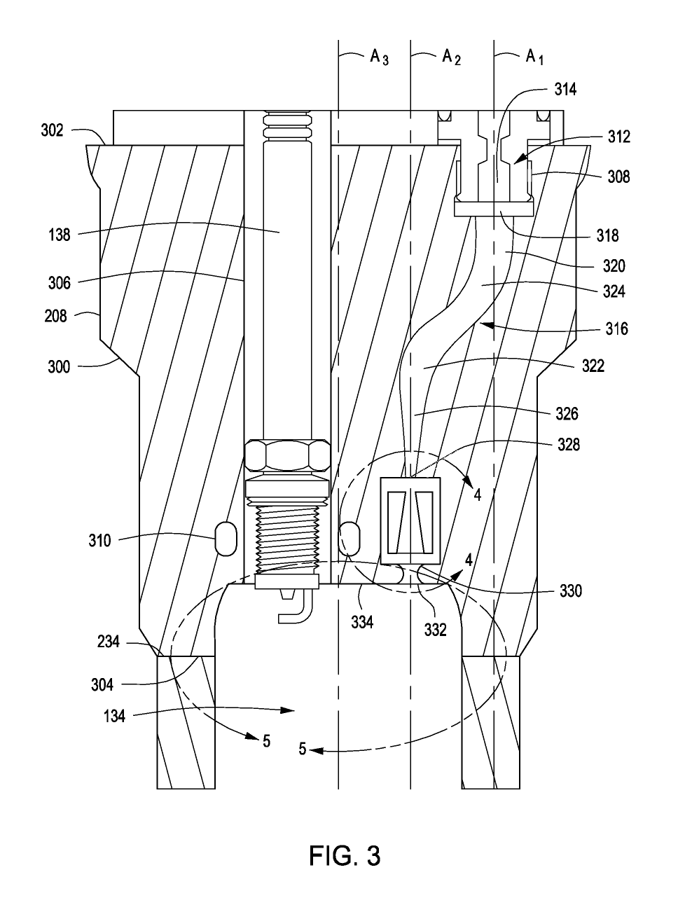

FIG. 3 illustrates an enlarged portion of FIG. 2, identified as Detail 3. As illustrated in FIG. 3, the second housing 208 includes a second housing body 300 extending from a first end 302 to a second end 304 of the second housing 208. Internal surfaces of the second housing body 300 may define a second housing ignition bore 306 and a second housing injector bore 308 corresponding to the first housing ignition bore 220 and first housing injector bore 222, respectively. The ignition device 138 may be positioned in the first housing ignition bore 220 and the second housing ignition bore 306. The second housing ignition bore 306 may be a stepped bore that may be adapted to receive a portion of the ignition device 138 extending from the first housing 204. The body 300 may define an internal fluid passage 310 that surrounds the second housing ignition bore 306, in order to cool the ignition device 138 during operation, as described in more detail below.

The second housing 208 may be made from any suitable material. For example, the second housing 208 may be made of a stainless steel material capable of withstanding relatively high temperatures, such as wrought stainless steel alloy, Type 347. Likewise, the second housing 208 may be connected to the tip 206 by any suitable means. For example, a controlled depth penetration weld, such as, a laser or electron beam weld, may be used to connect the second housing 208 to the first end 234 of the tip 206.

The second housing injector bore 308 may receive an outlet end 312 of the pre-chamber fuel injector 132 (FIG. 2), or merely be in fluid communication with a fuel delivery outlet 314 provided in the outlet end 312 of the pre-chamber fuel injector 132. The second housing injector bore 308 is in fluid communication with a fuel inlet conduit 316, which is defined by internal surfaces of the second housing body 300, via a conduit inlet 318. The conduit inlet 318 being at an end of an upstream end 320 of the fuel inlet conduit 316. The upstream end 320 extends along a first axis A₁ (hereafter referred to as “injector outlet axis A₁”) along which the fuel delivery outlet 314 of the pre-chamber fuel injector 132 also extends. The upstream end 320 is in fluid communication with the conduit inlet 318 and a downstream end 322 of the fuel inlet conduit 316. The downstream end 322 extends along a second axis defining a longitudinal axis A₂ (hereafter referred to as “oscillatory axis A₂”) of the fluidic oscillator 136 defined by second housing body 300.

Both the injector outlet axis A₁ and the oscillator axis A₂ are parallel to a longitudinal axis A₃ (hereafter referred to as “longitudinal axis A₃”) of the combustion pre-chamber assembly 130, which may be coaxial with a longitudinal axis of the pre-chamber 134. It will be appreciated that the pre-chamber 134 may be defined by the second housing body 300 such that the longitudinal axis of the pre-chamber 134 is not coaxial with the longitudinal axis A₃. The fuel inlet conduit 316 includes a transition 324 between the upstream end 320 and the downstream end 322 which may have a degree of curvature. The transition 324 may traverse a portion of the second housing body 300 between the injector outlet axis A₁ and the oscillator axis A₂. Walls of the second housing body 300 defining the fuel inlet conduit 316 may continuously converge from the conduit inlet 318 to a conduit outlet 326 positioned at the end of the downstream end 322. The conduit outlet 326 defines a convergent nozzle that is in fluid communication with an oscillator inlet 328 of the fluidic oscillator 136. Accordingly, a flow of fluid from the transition 324 and the downstream end 322 to the conduit outlet 326 is accelerated by a reduction in flow area through the conduit outlet 326 to form a fluid jet projecting into the fluidic oscillator 136. Thus, the structure of the conduit outlet 326 may align and accelerate a flow of fuel from the fuel inlet conduit 316 into the fluidic oscillator 136. As a result, an ability of the flow of fuel to latch to walls at the second housing body 300 defining the fuel inlet conduit 316 and the fluidic oscillator 136 may be reduced.

The fluidic oscillator 136 may be entirely defined by the second housing body 300 downstream of the fuel inlet conduit 316 and may include no moving parts. However, other configurations and arrangements may be implemented. The oscillator inlet 328 is in fluid communication with an oscillator outlet 330, which is in fluid communication with a pre-chamber delivery port 332. The pre-chamber delivery port 332 opens in a lower wall 334 of the second housing 208. The lower wall 334 of the second end 304 of the second housing 208 defines a second portion of the pre-chamber. Thus, the pre-chamber delivery port 332 is in fluid communication with the pre-chamber 134.

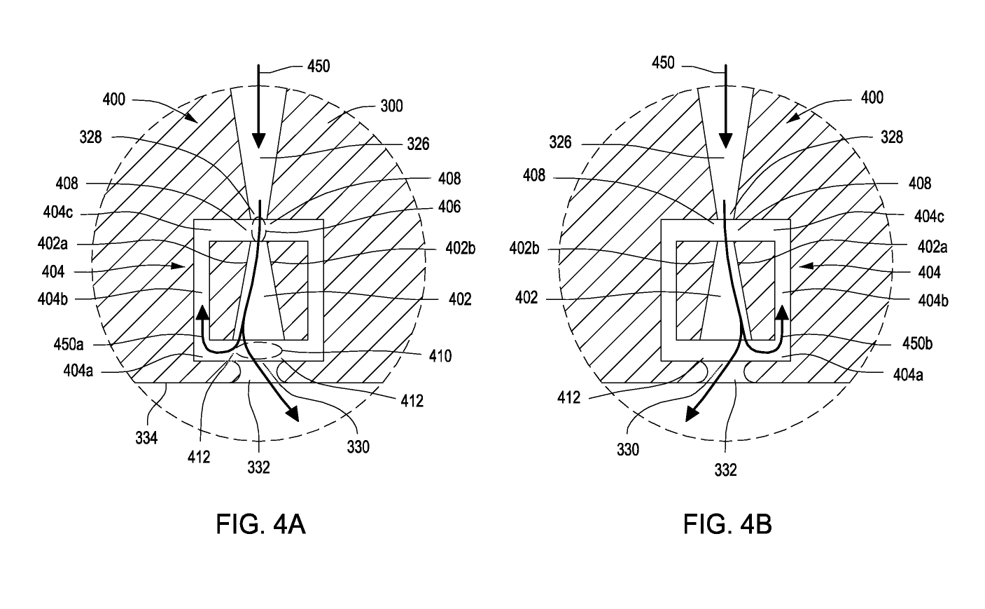

FIGS. 4A and 4B illustrate an enlarged portion of FIG. 3, identified as Detail 4. More specifically, FIGS. 4A and 4B illustrate a fluidic oscillator flow path 400 of the fluidic oscillator 136 including the oscillator inlet 328, a central oscillator conduit 402, feedback oscillator conduits (hereafter referred to as “feedback conduits”) 404, and the oscillator outlet 330. The oscillator inlet 328 is in fluid communication with the conduit outlet 326 and the central oscillator conduit 402 of the fluidic oscillator 136. The central oscillator conduit 402 is defined by a first oscillator wall 402a and a second oscillator wall 402b formed in the second housing body 300 upstream of the oscillator outlet 330. The first oscillator wall 402a and the second oscillator wall 402b may be diverging walls with the same or respective inclination angles. A first region 406 between the oscillator inlet 328 and the central oscillator conduit 402 is in fluid communication with the feedback conduits 404, and thus the oscillator outlet 330, through upstream ports 408 provided upstream of the central oscillator conduit 402. A second region 410 between the central oscillator conduit 402 and the oscillator outlet 330 is in fluid communication with the feedback conduits 404, and thus the oscillator inlet 328, through downstream ports 412 provided downstream of the central oscillator conduit 402.

The second housing body 300 may define the fluidic oscillator flow path 400 to include at least two feedback conduits 404 on opposite sides of the central oscillator conduit 402. The feedback conduits 404 may be equally spaced in a circumferential direction about the oscillator axis A₂ (i.e. two feedback conduits 404 are separated about the oscillator axis A₂ by 180°, four feedback conduits 404 are separated by 90°, etc.). The fluidic oscillator 136 may include an oscillator wall, such as the first oscillator wall 402a and second 402b, for each feedback conduit 404. The oscillator walls may be planer and equally spaced in the circumferential direction about the oscillator axis A₂. Each of the feedback conduits 404 may include a first sub-conduit 404a, a second sub-conduit 404b, and a third sub-conduit 404c. Each first-sub-conduit 404a and third sub-conduit 404c extends in a direction perpendicular to the oscillator axis A₂, and each second sub-conduit 404b extends parallel to the oscillator axis A₂. Alternatively, each feedback conduit 404 could be defined by the second housing body 300 as a single semi-circular conduit formed by continuously curved walls.

FIGS. 4A-B illustrate the fluidic oscillator 136 during an operation of the combustion pre-chamber assembly 130 in which the pre-chamber fuel injector 132 effects fluid communication between the fuel supply system 122 and the pre-chamber 134. Specifically, FIGS. 4A-B illustrate the fluidic oscillator 136 when a flow of fluid 450 is supplied to the oscillator inlet 328. The flow of fluid 450 may be a flow of fuel or a flow of a fuel/oxidizer mixture. The flow of fluid 450 is conveyed through the oscillator inlet 328 and the first region 406 as a jet due to the convergent nozzle provided by the conduit outlet 326. The first oscillator wall 402a and the second oscillator wall 402b have a length and an angle of inclination that are within respective ranges sufficient to provide a Coanda effect as the flow of fluid 450 flows through the fluidic oscillator 136. Accordingly, the flow of fluid 450 may bend and attach to either of the first oscillator wall 402a or the second oscillator wall 402b due to the Coanda effect.

For the purposes of the explanation that follows, the flow of fluid 450 initially attaches to the first oscillator wall 402a as illustrated in FIG. 4A. A distribution of pressure in the central oscillator conduit 402 is changed due to the flow of fluid 450 and a pulse of pressure may be generated by the jet attachment to first oscillator wall 402a of the flow of fluid 450. The pulse of pressure may be transmitted through the feedback conduit 404 adjacent to the first oscillator wall 402a in the form of a first portion of fluid 450a from the flow of fluid 450. As the first portion of fluid 450a flows into the feedback conduit 404, the remaining flow of fluid 450 is deflected in the second region 410 from a side of the fluidic oscillator 136 including the first oscillator wall 402a to a side of the fluidic oscillator including the second oscillator wall 402b, and through the oscillator outlet 330.

The pulse of pressure in the form of the first portion of the fluid 450a flowing through the feedback conduit 404 is transmitted into the first region 406 and deflects the flow of fluid 450 towards the second oscillator wall 402b. As a result, the flow of fluid 450 attaches to the second oscillator wall 402b. Accordingly, a pulse of pressure generated by the jet attachment to the second oscillator wall 402b of the flow of fluid 450 is transmitted through the feedback conduit 404 adjacent to the second oscillator wall 402b in the form of a second portion of fluid 450b from the flow of fluid 450. At the same time, as illustrated in FIG. 4B, the remaining flow of fluid 450 is deflected through the second region 410 to exit the fluidic oscillator 136 on the side of fluidic oscillator including the first oscillator wall 402a. The pulse of pressure in the form of the second portion of the fluid 450b flowing through the feedback conduit 404 is transmitted into the first region 406 and deflects the flow of fluid 450 towards the first oscillator wall 402a.

The process described herein may be repeated and a bi-stable flow in the fluidic oscillator 136 may persist as long as the flow of fluid 450 continues to be supplied. As the flow of fluid 450 continues to flow through the oscillator inlet 328, portions of the flow of fluid 450 continue to alternate between feedback conduits 404 in a cycle. As a result, the flow of fluid 450 may oscillate between sides of the fluidic oscillator 136 and cause the flow of fluid 450 to exit the oscillator outlet 330 in a pulsing or sweeping manner. Thus, the fluidic oscillator 136 may induce a fuel to be sprayed from the oscillator outlet 330 in a pulsing or sweeping flow pattern as described in more detail below.

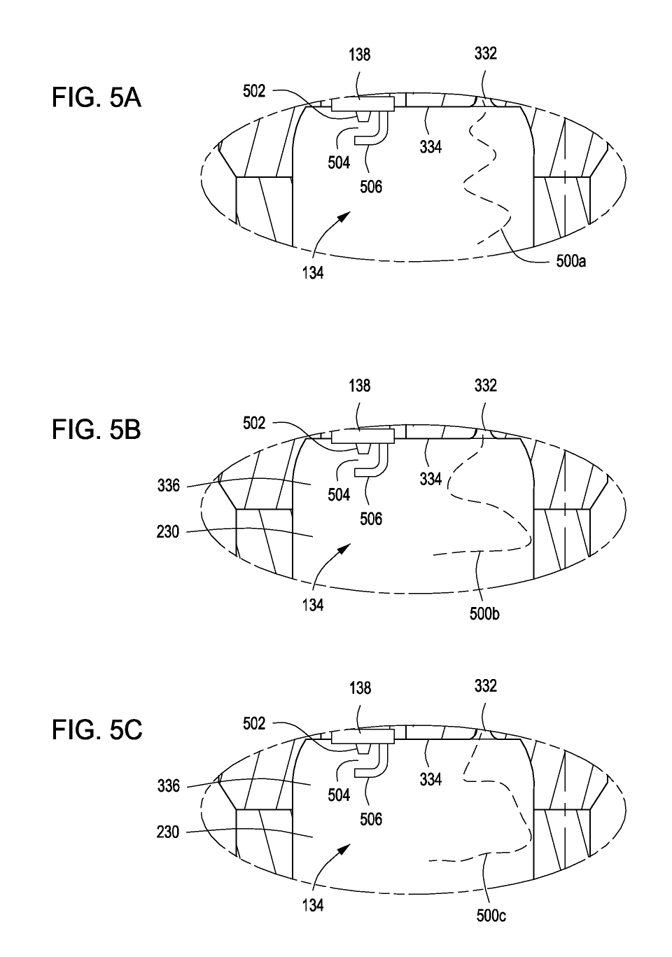

FIGS. 5A-C illustrate an enlarged portion of FIG. 3, identified as Detail 5. In particular, FIGS. 5A-C illustrate an area including a portion of pre-chamber 134, the ignition end 226 of the ignition device 138, and the pre-chamber delivery port 332. A sweeping or pulsing flow pattern of flow of fluid 450 may enter the pre-chamber delivery port 332 and be guided into the pre-chamber 134. It will be appreciated that an arrangement of the pre-chamber delivery port 332 and the fluidic oscillator 136 relative to the pre-chamber 134 illustrated in FIGS. 5A-C is exemplary, and other arrangements may be provided. For example, the pre-chamber delivery port 332 may be positioned closer to the longitudinal axis A₃ which may extend through a center of the pre-chamber 134.

The bi-stable flow in the fluidic oscillator 136 causing the flow of fluid 450 to oscillate between the sides of the fluidic oscillator 136 is passively induced by a structure of the of fluidic oscillator 136 having no moving parts. The bi-stable flow in the fluidic oscillator 136 may produce a sweeping or pulsing flow that exits the oscillator outlet 330 and the pre-chamber delivery port 332 in multiple flow patterns as illustrated in FIGS. 5A-C. The frequency of oscillation will be determined by a supply pressure, flow rate, or both, of the flow of fluid 450 and structural dimensions of the fluidic oscillator 136. For example, increasing the supply pressure of the flow of fluid 450 may result in higher frequencies of oscillation. A geometry of wall attachment regions (i.e. dimension and shape of oscillator walls such as the first oscillator wall 402a and the second oscillator wall 402b), and a length of the feedback conduits 404 may be constructed according to a desired dwell time of the flow of fluid 450 at specific locations within the fluidic oscillator 136, and desired modes of oscillation. As a result, a profile of a flow pattern entering the pre-chamber 134 from the pre-chamber delivery port 332 may be in a form of a wave such as a sine wave 500a, a sawtooth wave 500b, and a rectangular wave 500c as illustrated in FIGS. 5A-C, respectively. According to another aspect of the present disclosure, incorporation of the fluidic oscillator 136 may generally produce a turbulent flow of a fuel or a fuel/oxidizer mixture to flow into the pre-chamber 134.

It is noted that a pair of diverging walls formed within the second housing body 300, extend from the oscillator outlet 330 and define pre-chamber delivery port 332. It will be appreciated that the diverging walls could be formed in other configurations and lengths suitable for directing fluid from the fluidic oscillator 136 into the pre-chamber 134 according to a desired flow pattern. For example, an angle between the diverging walls may be modified, or walls between the oscillator outlet and the pre-chamber delivery port 332 may be short and bell shaped. The configuration of the pre-chamber delivery port 332 may affect the profile of a flow pattern of a sweeping or pulsing flow of fluid entering the pre-chamber 134. For example, a desired amplitude of a waveform resulting from a sweeping or pulsing flow exiting the oscillator outlet 330 and entering the pre-chamber 134 may be obtained by modifying a spread, angle, and length of walls defining the pre-chamber delivery port 332.

During operation, supply of the ignition energy may cause, for example, arcing across a gap 504 between a first electrode 502 and a second electrode 506 of the ignition device 138 illustrated in FIGS. 5A-C, and ignite a combustion reaction with a mixture of fluids, described in more detail below, in the pre-chamber 134. The combustion in the pre-chamber 134 may propagate and expel expanding gases through the plurality of orifices 232 of the tip 206 and ignite a main fuel charge in the main combustion chamber 110. A flame from the pre-chamber 134 may propagate on multiple fronts through the plurality of orifices 232. According to an aspect of the disclosure, a transverse dimension of one or more of the plurality of orifices 232 is less than 25% of a transverse dimension of the combustion pre-chamber 134. According to another aspect of the disclosure, a transverse dimension of one or more of the plurality of orifices 232 may be less than 15% of a transverse dimension of the combustion pre-chamber 134. Accordingly, fluid flow from the combustion pre-chamber 134 to the main combustion chamber 110 via the plurality of orifices 232 is accelerated by a reduction in flow area through the plurality of orifices 232 to form fluid jets projecting into the main combustion chamber 110.

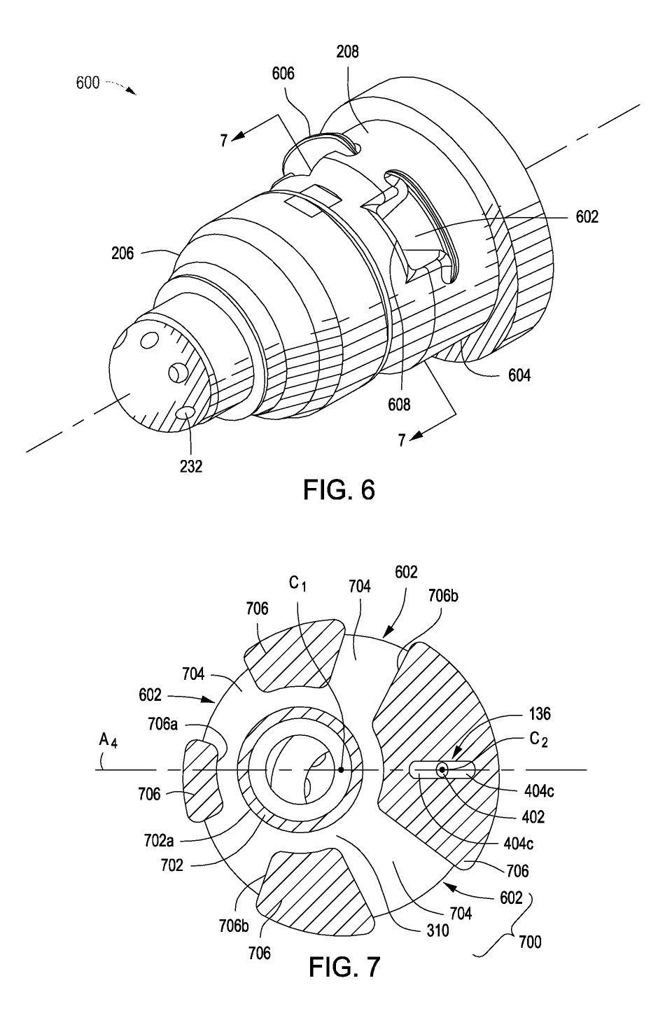

FIG. 6 illustrates an isometric view of a sub-assembly 600 for the combustion pre-chamber assembly 130 of FIG. 2, according to an aspect of the present disclosure. The sub-assembly 600 includes the tip 206 and the second housing 208, with the first end 234 of the tip 206 attached to a second end 304 of the second housing 208 by any suitable means, such as a brazing or welding, as discussed above. FIG. 6 further illustrates an outer surface 604 of the second housing 208, and fluid passageway openings 602 formed in the outer surface 604 which open to an area surrounding the sub-assembly 600. A ridge 606 may extend from the outer surface 604 on one side of each fluid passageway opening 602 along a longitudinal axis A₃ of the combustion pre-chamber assembly 130 including the sub-assembly 600. In addition, a lower edge 608 may be formed in the outer surface 604 on a side of each fluid passageway opening 602 opposite to a side including a respective ridge 606.

FIG. 7 illustrates a top cross sectional view of the sub-assembly 600 of FIG. 6, taken along section line 7-7. A fluid passageway 700 is formed in the second housing 208 around a cylindrical wall 702 that defines the second housing ignition bore 306. The fluid passageway 700 includes the internal fluid passage 310 and outwardly extending passages 704 defined between wall sections 706 of the second housing 208 and extending in radial directions from the internal fluid passage 310. The internal fluid passage 310 is defined by an outer surface 702a of the cylindrical wall 702 and inner side surfaces 706a of the wall sections 706 which surround the cylindrical wall 702. The inner side surfaces 706a are radially spaced from the outer surface 702a of the cylindrical wall 702 and connected to end surfaces 706b of the wall sections 706 which define the outwardly extending passages 704.

The fluid passageway 700 is adapted to pass fluid in close proximity relative to the second housing ignition bore 306. In particular, the outwardly extending passages 704 are in fluid communication with the fluid passageway openings 602 and configured to pass fluid through the second housing 208 via the internal fluid passage 310. With reference to FIGS. 2, 6, and 7, the tip 206 is positioned in the cylinder head 108 adjacent to the fluid delivery conduit 202. Fluid flowing from the fluid delivery conduit 202 flows around the tip 206 and upward into the main fluid passage 201. As the fluid flows upward toward the main fluid passage 201, the ridges 606 associated with the fluid passageway openings 602 divert some of the fluid into the fluid passageway openings 602 and corresponding outwardly extending passages 704. In addition, the lower edges 608 of the fluid passageway openings 602 may provide a relatively low flow resistance path for the diverted fluid. Thus, sub-assembly 600, and thus the combustion pre-chamber assembly 130, may include structural elements that facilitate the flow of fluid through the fluid passageway 700 in the second housing 208.

As illustrated in FIG. 7, the fluidic oscillator 136 is formed within one of the wall sections 706 that define the fluid passageway 700. The fluidic oscillator 136 includes two feedback conduits 404 with third sub-conduits 404c extending on opposite sides of a first region 406 along a transverse axis A₄ of the second housing 208. The first sub-conduits 404a (not shown) are parallel to the third sub-conduits 404c. A housing center C₁ of the second housing 208 and an oscillator center C₂ of the fluidic oscillator 136 are located along the transverse axis A₄. The oscillator center C₂ may also be positioned along an oscillator axis A₂.

It will be appreciated that the fluidic oscillator 136 may be defined within the second housing so that the first and third sub-conduits (404a, 404c) are orientated at an angle relative to the transverse axis A₄. In other arrangements the oscillator center C₂ may not be located along the transverse axis A₄ and the first and third sub-conduits (404a, 404c) may extend parallel or at an angle relative to the transverse axis A₄.

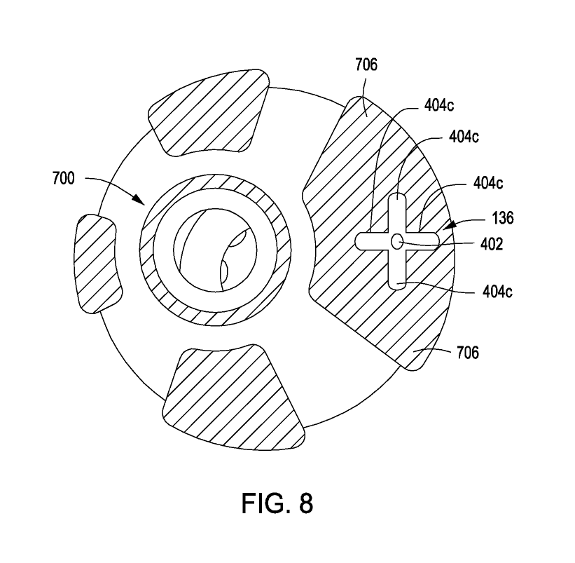

FIG. 8 illustrates a top cross sectional view of the sub-assembly 600 of FIG. 6, taken along section line 7-7, modified according to one aspect of the present disclosure. In particular, the fluidic oscillator 136 of FIG. 8 includes four feedback conduits 404. The feedback conduits 404 being equally spaced in a circumferential direction about an oscillator axis A₂ of the fluidic oscillator 136 as previously discussed. Providing four feedback conduits 404 may increase the number of flow patterns for fluid exiting the oscillator outlet 330, given various supply pressures, the fluidic oscillator 136 is able to produce. In addition, the flow patterns produced by the fluidic oscillator 136 with four feedback conduits 404 may further enhance mixing of fluids within the pre-chamber 134 during operation. One of ordinary skill in the art will recognize that other configurations of the fluidic oscillator 136 may include different numbers of the feedback conduits 404. As previously discussed with reference to FIG. 4, an oscillator wall may be formed within the second housing body 300, such as the first oscillator wall 402a and second oscillator wall 402b, for each feedback conduit 404.

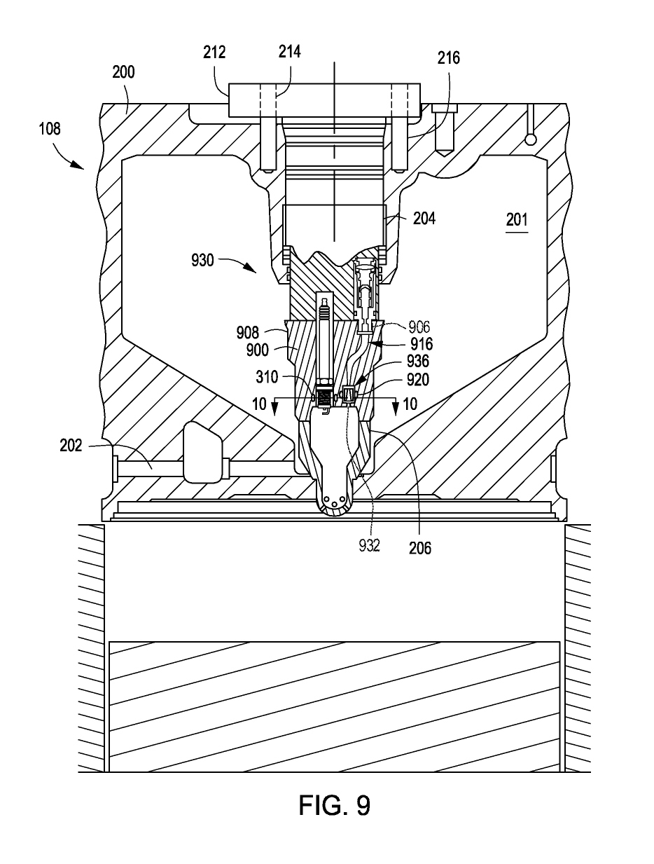

FIG. 9 illustrates a front cross sectional view of a cylinder head 108 including a combustion pre-chamber assembly 930, according to an aspect of the present disclosure. The combustion pre-chamber assembly 930 is positioned within the main fluid passage 201 defined within the cylinder head 108. The fluid delivery conduit 202 supplies fluid to the main fluid passage 201 to cool the combustion pre-chamber assembly 930. The combustion pre-chamber assembly 930 may include the first housing 204, a second housing 908 attached to the first housing 204, and the tip 206 attached to the second housing 908. The second housing 908 includes a second housing body 900, which may define a second housing ignition bore 906, a fuel inlet conduit 916, and a fluidic oscillator 936 in fluid communication with the fuel inlet conduit 916.

The second housing ignition bore 906 may be a stepped bore adapted to receive a portion of the ignition device 138. The second housing body 900 may define a first internal fluid passage 910 that surrounds the second housing ignition bore 906, in order to cool the ignition device 138 during operation. In addition, the second housing body 900 may define a second internal fluid passage 920 that surrounds a portion of the fluidic oscillator 936 and/or a pre-chamber delivery port 932 in fluid communication with the fluidic oscillator 936.

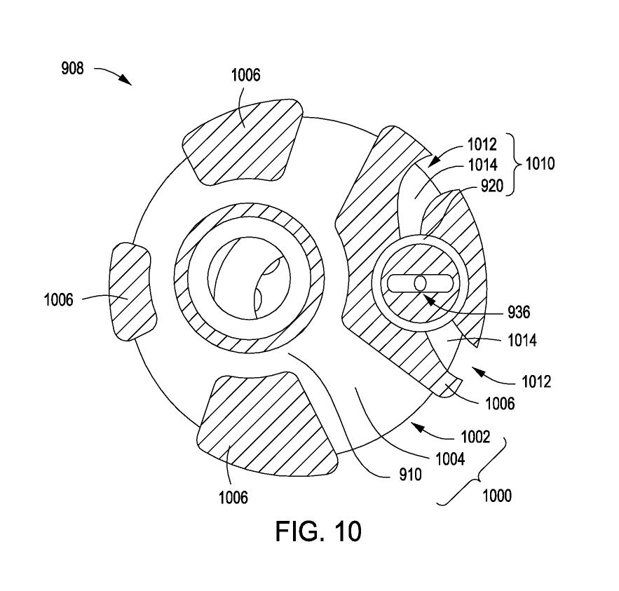

FIG. 10 illustrates a top cross sectional view of the second housing of FIG. 9, taken along a section line 10-10. A first fluid passageway 1000 is formed in the second housing 908 and includes the first internal fluid passage 910, and first outwardly extending passages 1004 which extend between wall sections 1006. The first outwardly extending passages 1004 are in fluid communication with first fluid passageway openings 1002 and configured to pass fluid through the second housing 908 via the first internal passage 910. In addition, a second fluid passageway 1010 is formed in a wall section 1006 including the fluidic oscillator 936. The second fluid passageway 1010 includes the second internal fluid passage 920, second fluid passageway openings 1012, and second outwardly extending passages 1014. The second fluid passageway openings 1012 and second outwardly extending passages 1014 are formed in the wall section 1006 in fluid communication with the second internal fluid passage 920 as illustrated in FIG. 10.

The first fluid passageway 1000 and the second fluid passageway 1010 are adapted to pass fluid in close proximity relative to the second housing ignition bore 906 and the fluidic oscillator 936, respectively. With reference to FIG. 9, the tip 206 is positioned in the cylinder head 108 adjacent to the fluid delivery conduit 202. Fluid flowing from the fluid delivery conduit 202 flows around the tip 206 and upward into the main fluid passage 201. Similar to the sub-assembly 600 illustrated in FIG. 6, as the fluid flows upward toward the main fluid passage 201, some of the fluid may be diverted into the first outwardly extending passages 1004 and second outwardly extending passages 1014. As fluid flows in the second fluid passageway 1010 around the fluidic oscillator 936, sections of the second housing body 900 (FIG. 9) defining the fuel inlet conduit 916, the fluidic oscillator 936, and the pre-chamber delivery port 932, and fuel flowing there through, may be cooled. Cooling the fuel flowing through the fluidic oscillator 936 may help prevent oil from clumping along the fluidic oscillator 936 and the pre-chamber delivery port 932.

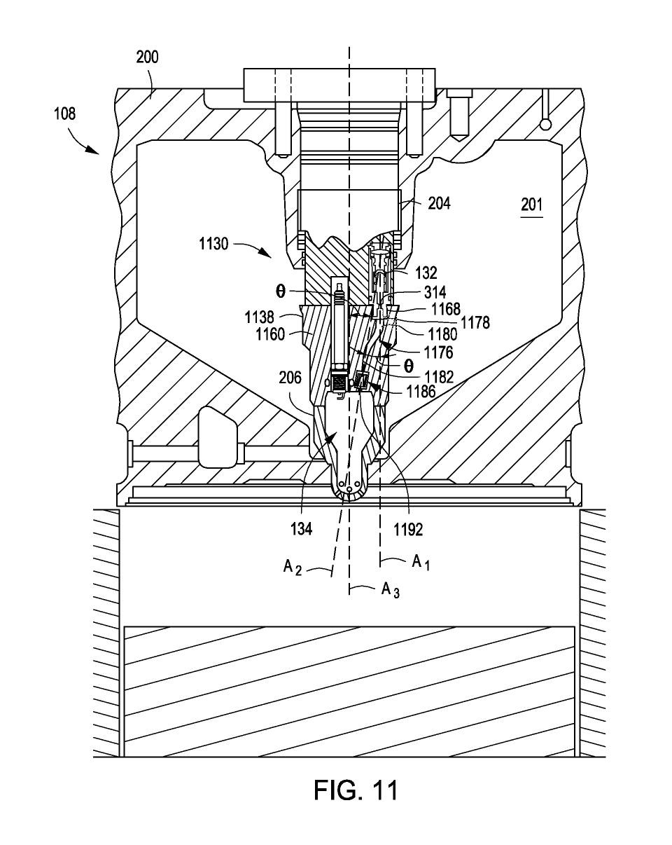

FIG. 11 illustrates a front cross sectional view of a cylinder head 108 including a combustion pre-chamber assembly 1130, according to an aspect of the present disclosure. The combustion pre-chamber assembly 1130 is positioned within a main fluid passage 201 defined within the cylinder head 108. The combustion pre-chamber assembly 1130 may include the first housing 204, a second housing 1138 attached to the first housing 204, and the tip 206 attached to the second housing 1138. The second housing 1138 may include a second housing body 1160, which may define a second housing injector bore 1168, a fuel inlet conduit 1176, and a fluidic oscillator 1186 in fluid communication with the fuel inlet conduit 1176.

The second housing injector bore 1168 is in fluid communication with a conduit inlet 1178 of the fuel inlet conduit 1176 defined by the second housing body 1160. The conduit inlet 1178 being at an end of an upstream end 1180 of the fuel inlet conduit 1176. The upstream end 1180 extends along an injector outlet axis A1 along which the fuel delivery outlet 314 of the pre-chamber fuel injector 132 also extends. The upstream end 1180 is in fluid communication with the conduit inlet 1178 and a downstream end 1182 of the fuel inlet conduit 1176. The downstream end 1182 extends along an oscillator axis A2 of the fluidic oscillator 1186 defined by second housing body 1160.

The injector outlet axis A1 is parallel to a longitudinal axis A3 of the combustion pre-chamber assembly 1130, whereas the oscillatory axis A2 is orientated at an oscillator angle θ relative to the longitudinal axis A3. The oscillator angle θ may be within a range of between 250-45 o, preferably 45 o, in order for an oscillator outlet 1190 to be pointed in a direction towards the longitudinal axis A3, and potentially a center of the pre-chamber 134 located along the longitudinal axis A3. In this arrangement, fuel exiting the pre-chamber delivery port 1192 may be directed to a center of a non-swirling flow of fluid mixture flowing from the plurality of orifices 232 in the tip 206, and effectively entrained by the non-swirling flow. It will be appreciated that in a configuration in which the longitudinal axis A3 is not coaxial with a longitudinal axis of the pre-chamber 134, the oscillator angle θ may be provided relative to the longitudinal axis of the pre-chamber 134.

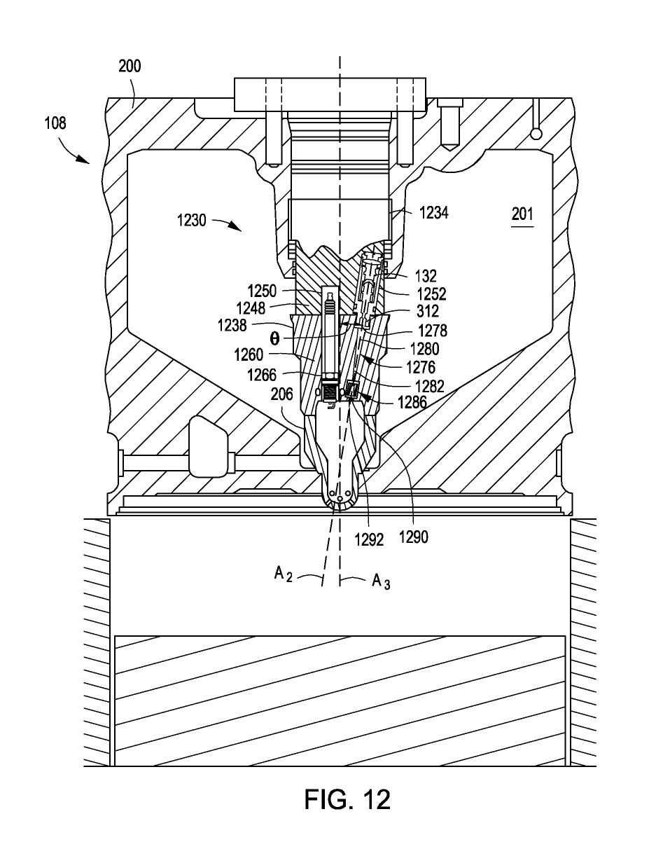

FIG. 12 illustrates a front cross sectional view of a combustion pre-chamber assembly 1230, according to an aspect of the present disclosure. The combustion pre-chamber assembly 1230 is positioned within the main fluid passage 201 defined within the cylinder head 108. The combustion pre-chamber assembly 1230 may include a first housing 1234, a second housing 1238 attached to the first housing 1234, and the tip 206 attached to the second housing 1238. The first housing 1234 includes a first housing body 1248 that defines a first housing ignition bore 1250 and a first housing injector bore 1252. The second housing 1238 includes a second housing body 1260, which may define a second housing ignition bore 1266, a second housing injector bore 1268, a fuel inlet conduit 1276, and a fluidic oscillator 1286 in fluid communication with the fuel inlet conduit 1276.

The first housing injector bore 1252 may receive the pre-chamber fuel injector 132 as illustrated in FIG. 12. The second housing injector bore 308 may receive an outlet end 312 of the pre-chamber fuel injector 132, or merely be in fluid communication with a fuel delivery outlet 314 of the pre-chamber fuel injector 132. The second housing injector bore 1268 is in fluid communication with a conduit inlet 1278 of a fuel inlet conduit 1276 defined by the second housing body 1260. The conduit inlet 1278 being at an end of an upstream end 1280 of the fuel inlet conduit 1276 that is in fluid communication with a downstream end 1282 of the fuel inlet conduit 1276, which is in fluid communication with a fluidic oscillator 1286 defined by the second housing body 1260.

Each of the first housing injector bore 1252, the second housing injector bore 1268, the upstream end 1280 and downstream end 1282 of the fuel inlet conduit 1276, and the fluidic oscillator 1286 extend along an oscillator axis A2 orientated at an oscillator angle θ relative to a longitudinal axis A3 of the combustion pre-chamber assembly 1230. Accordingly, the fuel inlet conduit 1276 is provided as a straight continuously converging conduit. In turn, a loss of pressure due to fluid flowing through bends in the fuel inlet conduit 1276 may be reduced. Increasing, or providing an ability to increase, a supply pressure to the fluidic oscillator 1286, may allow for a desired flow pattern of fuel exiting fluidic oscillator 1286 to be produced.

Space constraints in the first housing 1234 with respect to the pre-chamber fuel injector 132 may determine an upper limit for a range for the oscillator angle θ. However, the oscillator axis A2 may still be orientated so as to intersect with the longitudinal axis A3, which may include passing through a center of the pre-chamber 134. Thus, a flow of fuel in a given flow pattern may be directed towards the center of the pre-chamber 134, a degree of mixing between a fluid exiting an oscillator outlet 1290 and a pre-chamber delivery port 1292, and fluids flowing into the pre-chamber 134 through the plurality of orifices 232, may be increased. Alternatively, the upstream end 1280 of the fuel inlet conduit 1276 may be orientated at a second angle relative to the longitudinal axis A3 that is greater than the oscillator angle θ, but not parallel to the longitudinal axis A3, in order to minimize a degree of change in direction of fluid flowing through the fuel inlet conduit 1276.

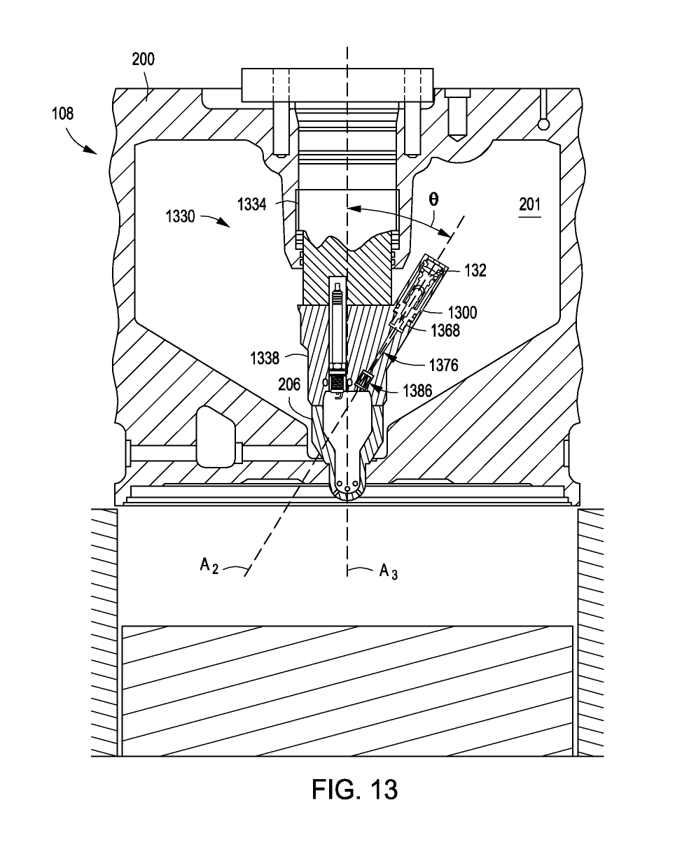

FIG. 13 illustrates a front cross sectional view of a combustion pre-chamber assembly 1330, according to an aspect of the present disclosure. The combustion pre-chamber assembly 1330 is positioned within the main fluid passage 201 defined by the cylinder head body 200 of cylinder head 108. The combustion pre-chamber assembly 1330 may include a first housing 1334, a second housing 1338 attached to the first housing 1334, and the tip 206 attached to the second housing 1338. As illustrated in FIG. 13, an injector housing 1300 extends at an angle from the second housing 1338. It will be appreciated that the injector housing 1300 may extend from the first housing 1334. The second housing 1338 may include a second housing injector bore 1168 which receives an end of the pre-chamber fuel injector 132 provided in the injector housing 1300.

Each of the injector housing 1300, the second housing injector bore 1368, a fuel inlet conduit 1376 in fluid communication with the second housing injector bore 1368, and a fluidic oscillator 1386 in fluid communication with the fuel inlet conduit 1376, may extend along an oscillator axis A₂ orientated at an oscillator angle θ relative to a longitudinal axis A₃ of the combustion pre-chamber assembly 1330. Providing the pre-chamber fuel injector 132 in the injector housing 1300 allows for the components discussed herein to be orientated at an oscillator angle θ that is greater than 45° relative to the longitudinal axis A₃. Thus, including the injector housing 1300 may result in more design freedom with respect to an angle of an axis that a flow pattern of fluid exiting the fluidic oscillator 1386 can oscillate relative to, and a location in a pre-chamber 134 the flow pattern can be directed towards.

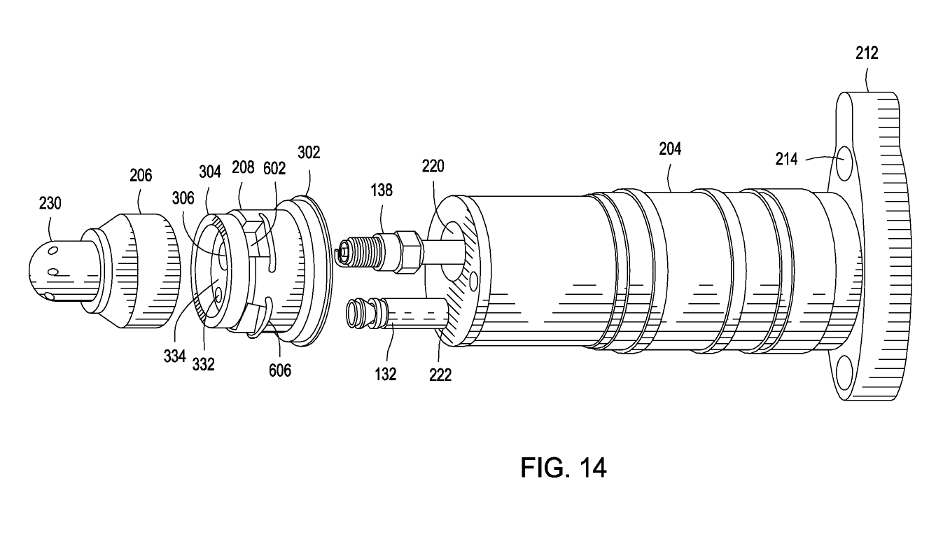

Reference is now made to FIG. 14, which illustrates an exploded view of the pre-chamber assembly 130 of FIG. 2, for a discussion regarding potential manufacturing techniques for constructing the combustion pre-chamber assembly 130. However, it will be appreciated that the following description with respect to manufacturing the combustion pre-chamber assembly 130 is equally applicable to each of the other pre-chamber assemblies (930, 1130, 1230, 1330) described herein, and particularly applicable to each of the other second housings (908, 1138, 1238, 1338) described herein.

The combustion pre-chamber assembly 130 includes the first housing 204, the tip 206, and the second housing 208 between the first housing 204 and the tip 206. The pre-chamber fuel injector 132 and the ignition device 138 are received in the first housing ignition bore 220 and the first housing injector bore 222, respectively. The tip 206 is provided with the plurality of orifices 232. The second housing 208 includes the first end 302 and the second end 304, with a portion of the pre-chamber 134 being defined at the second end 304 by the lower wall 334. The second housing ignition bore 306 and the pre-chamber delivery port 332 are formed through the lower wall. The fluid passageway openings 602 are formed in the outer surface 604 of the second housing 208.

The second housing 208 is illustrated in FIG. 14 in a post-production and pre-assembled state, and may include the fluidic oscillator 136, or as will be appreciated, any of the other fluidic oscillators (936, 1186, 1286, 1386) described herein, or variations thereof. Each of the first housing 204, the tip 206, and the second housing 208 may be manufactured by any known method. In particular, the second housing 208 may be formed by Additive Manufacturing (AM).

Manufacturing methods such as AM or Solid Freeform Fabrication (SFF) of metal parts can be used to fabricate an intricately shaped structure of a second housing including a fluidic oscillator formed therein, directly from computer data via additive formation steps. For example, a three-dimensional computer model of a second housing that includes a fluidic oscillator extending parallel or at an angle relative to a longitudinal axis of combustion pre-chamber assembly can be sliced into thin cross-sections. The resulting cross-sections can be translated into two-dimensional position data that can be fed to control equipment that fabricates a metal three-dimensional structure in a layerwise manner. Thus, components that must withstand high temperatures during an operation of a machine or apparatus in which the components are incorporated, such as a second housing according to the present disclosure, can be produced using metal AM of SFF manufacturing techniques.

According to another aspect of the present disclosure, a main shell for a second housing may be created from bits of granular material that are adhered, fused, or otherwise bonded to one another at points of contact between adjacent bits of granular material, leaving pores or voids between adjacent bits of granular material that do not share a point of contact, utilizing an AM process. The main shell may be additively manufactured to include a lower wall and a cylinder extending from the lower wall. The lower wall may be manufactured on an end of the main shell corresponding to a second end of a second housing, and the cylinder may correspond to a second housing ignition bore. In addition, the main shell may be additively manufactured with an internal shell extending from the lower wall. The internal shell may be in a shape of a shell formed around a pre-chamber delivery port, a fluidic oscillator, a fuel inlet conduit, and a second housing injector bore. The main shell may be immersed in, or sprayed, or otherwise quenched with a heat transfer medium. Ends of the cylinder and the internal shell on an end of the main shell corresponding to a first end of a second housing may be covered, and the main shell may be filled, as by injection or a casting process, with a fluid filler material that is selected to bond with the main shell. The fluid filler material may fill the pores in the main shell and solidify.

Additional AM processes that may be utilized may include, but are not limited to: stereolithography; photopolymerization stereolithography; mask image stereolithography; metal-sintering; selective laser sintering; direct metal laser sintering; selective laser melting; laser engineered net shaping; wire arc processes; electron beam melting; fused deposition modeling; inkjet deposition; polyjet printing; inkjet material deposition; drop-on-drop material deposition; laminated object manufacturing; subtractive manufacturing processes; combined additive and subtractive manufacturing processes; Arburg Kunststoff free forming; combinations thereof; and any other additive manufacturing processes know in the art.

The above manufacturing technique can be performed in a short time period, which allows for testing of numerous configurations of fluidic oscillators. It will be appreciated that a length and number of feedback channels, sizes of an oscillator inlet and/or oscillator outlet, an inclination angle of oscillator walls of a central oscillator conduit or a fluid delivery port, a length of the fluid delivery port, or sizes of sub-conduits can be varied according to predicative fluid behavior data and different second housings may be easily and rapidly manufactured.

Once produced, second housings can be tested by flowing fluid through a fuel inlet conduit and observing a flow pattern of fluid exiting the fluid delivery port. In other testing methods, a second housing can be attached to a tip and a combustion event in the pre-chamber can be simulated to test a degree of oxidizer and fuel mixing, NOx levels, thermal efficiency, and peak surface temperatures of a pre-chamber. In addition, the combustion event can be simulated multiple times for a sub-assembly including a tip and a second housing to determine which arrangements for a fluidic oscillator yield longer life-cycles for a pre-chamber.

As described herein, a combustion pre-chamber assembly is provided with a fluidic oscillator for supplying fuel from a pre-chamber fuel injector into a pre-chamber, to be mixed with a mixture of fluids within the pre-chamber. It will be appreciated that a fluidic oscillator may also be provided between a main fuel injector and an intake duct or a main combustion chamber. Producing a bi-stable flow in a fluidic oscillator provided within or generally downstream of a main fuel injector, may yield a sweeping/pulsing flow, or a generally turbulent flow, of fuel to flow from an oscillator outlet and into an intake duct or a main combustion chamber. As such, a more complete mixture of fuel with a fluid mixture within an intake duct or a main combustion chamber may result.

### INDUSTRIAL APPLICABILITY

Operation of the IC engine 100 will now be described with reference to FIGS. 1, 2, 4A, 4B, and 5A-C. However, it will be appreciated that the following description with respect to manufacturing the combustion pre-chamber assembly 130 illustrated FIGS. 1, 2, 4A, 4B, and 5A-C, is equally applicable to each of the other pre-chamber assemblies (930, 1130, 1230, 1330) described herein and illustrated in FIGS. 9 and 11-13, and particularly applicable to each of the other second housings (908, 1138, 1238, 1338) described herein.

Beginning with a gas-exchange process, the exhaust valve 118 may open to allow exhaust gas to evacuate the main combustion chamber 110 through the exhaust duct 120. At the same time, the piston 106 may move upward in the main combustion chamber 110 to TDC, such that the exhaust (E) is conveyed through the exhaust duct 120 with a motion of the piston 106. Concurrently, fuel injection through the main fuel injector 124 and the pre-chamber fuel injector 132, may be initiated to start a flow of fuel into the intake duct 114 and the pre-chamber 134, respectively. Fuel in the intake duct 114 may be mixed with oxidizer to produce a lean fuel/oxidizer mixture to be delivered to the main combustion chamber 110. In addition, fuel will be delivered through the fluidic oscillator 136 as illustrated in FIGS. 4A and 4B, into the pre-chamber 134 as a generally turbulent, or a sweeping/pulsing jet following a flow pattern which may be in a wave form such as one of the waveforms illustrated in FIGS. 5A-C. The flow pattern will be effected by a supply pressure of a flow of fluid 450, and by geometric dimensions of the oscillator walls such as the first and second oscillator walls (402a, 402b), the feedback conduits 404, and the pre-chamber delivery port 332.

Once the exhaust gas E is sufficiently evacuated from the main combustion chamber 110, the intake valve 116 may open to allow a fresh lean fuel/oxidizer mixture (I) to enter the main combustion chamber 110 from the intake duct 114 and replace the evacuated exhaust gases, and the exhaust valve 118 may close. A vacuum created in the main combustion chamber 110 by the downward motion of the piston 106 may draw the fresh lean fuel/oxidizer mixture (I) into the main combustion chamber 110. The downward movement of the piston 106 may also draw a mixture of fluids through the plurality of orifices 232 in the tip 206 and into the main combustion chamber 110. However, fuel, oxidizer, or both from the main combustion chamber 110 may also flow into the pre-chamber 134 via the plurality of orifices 232 during the intake stroke by diffusion, convection driven by a charge motion within the main combustion chamber 110, or other mass transport processes. In addition, the pre-chamber fuel injector 132 will continue to supply fuel to the fluidic oscillator 136, which in turn will cause a generally turbulent flow or a sweeping/pulsing jet flow of fuel to flow into the pre-chamber 134 and be mixed with a fluid mixture in the pre-chamber 134.

After completion of the gas-exchange process, a compression stage may begin. Specifically as the piston 106 moves from BDC toward TDC, injection of fuel in the intake duct 114 and the pre-chamber 134 may be terminated and the intake valve 116 may be closed. It should be noted that fuel may flow from the pre-chamber fuel injector 132 directly into the pre-chamber 134 over a time period spanning from about 500 degrees crank angle before the piston 106 reaches TDC of a compression stroke, until about the time the intake valve 116 is closed. Accordingly, the intake valve 116 may be closed, and the fresh lean fuel/oxidizer mixture (I) and a combined mixture from the pre-chamber 134 now in the main combustion chamber 110 as a result of the previous downward movement of the piston 106, may be compressed as a total fluid mixture by the upward movement of the piston 106. The upward motion of the piston 106 may force some of the total fluid mixture into the pre-chamber 134 via the plurality of orifices 232.

High temperature combustion of the total fluid mixture in the main combustion chamber 110 may then be initiated by ignition of the ignition device 138. In particular, ignition of the by the ignition device 138 may produce a high temperature flame that jets out of the plurality of orifices 232 and ignites a fluid mixture in the main combustion chamber 110. The combustion in the main combustion chamber 110 releases sufficient energy to drive the downward movement of the piston 106; the piston cycle may then repeat.

The fluidic oscillator 136 having two feedback conduits 404, may, during the period of time that the fuel flows through the pre-chamber fuel injector 132, cause fuel to flip flop across (sweep across) the oscillator outlet 330 several times. With the fluidic oscillator 136 including four feedback conduits 404, fuel may be passed sequentially through each feedback channel in a short period of time creating a spinning jet.

As illustrated in FIGS. 2 and 11-13, an oscillator axis A₂ may be orientated at various oscillator angles θ. Any of the fluidic oscillators (136, 936, 1136, 1236, 1326) described herein may be formed along an particular axis in order for fuel exiting therefrom to be directed toward an area within the pre-chamber 134 in which the fuel/oxidizer mixture flows or is in a turbulent state in order to promote more complete mixing therewith. For example, if the contours of the walls that define the pre-chamber 134 promote a swirling action of the fuel/oxidizer during, for example, the compression stroke when a mixture of fluid flows into the pre-chamber 134, the oscillator axis A₂ may be orientated as in FIG. 2. Thus, as the fuel/oxidizer mixture swirls along an outer area near the walls defining the pre-chamber 134, fuel from the fluidic oscillator 136 will be injected directly into the flow of the fuel/oxidizer mixture and more effectively mixed therewith.

The enhanced mixing of the fuel from the pre-chamber fuel injector 132 and the fuel/oxidizer mixture within the pre-chamber 134 may promote several advantages given the size of the pre-chamber 134 and time allowed for fluid mixing during a combustion cycle. Fuel delivered to the pre-chamber 134 may be less than about 3% of the total fuel delivered to the main combustion chamber 110 during the same combustion cycle. In addition, a speed of a combustion cycle may not allow for a substantial amount of time for fuel from the pre-chamber fuel injector 132 to mix with the fuel/oxidizer mixture in the pre-chamber 134. A turbulent or sweeping/pulsing flow of fuel into pre-chamber 134 produced by any of the fluidic oscillators (136, 936, 1136, 1236, 1336) described herein, may result in fuel from the pre-chamber fuel injector 132 being better entrained by and mixed with the fuel/oxidizer mixture in the pre-chamber 134 in the short period of time during which the fuel is injected before a combustion event.

According to an aspect of the present disclosure, increasing a degree to which a fuel supplied from the pre-chamber fuel injector 132 is mixed with the fuel/oxidizer mixture in the pre-chamber 134 may result in a greater amount of fuel being ignited during a combustion process. Accordingly, a more complete combustion of a total combined fuel/oxidizer mixture in the pre-chamber 134 and the main combustion chamber 110 may result. Further, an increased degree of mixing as discussed may produce lower NOx levels, increased thermal efficiency, and lower peak pre-chamber surface temperatures during operation of the IC engine 100, and increase an operating life of the pre-chamber 134.

Any of the methods or functions described herein may be performed by or controlled by the controller 126. Further, any of the methods or functions described herein may be embodied in a machine-readable non-transitory medium for causing the controller 126 to perform the methods or functions described herein. Such machine-readable non-transitory media may include magnetic disks, optical discs, solid state disk drives, combinations thereof, or any other computer-readable non-transitory medium known in the art. Moreover, it will be appreciated that the methods and functions described herein may be incorporated into larger control schemes for an engine, a machine, or combinations thereof, including other methods and functions not described herein.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

We claim:

1. A combustion pre-chamber assembly for a reciprocating internal combustion engine, the combustion pre-chamber assembly comprising:
a body that defines:
a combustion pre-chamber,
a plurality of orifices that extend through the body and effect fluid communication between the combustion pre-chamber and a main combustion chamber of the reciprocating internal combustion engine,
a fuel inlet conduit, and
a fluidic oscillator flow path with an oscillator inlet in fluid communication with an outlet of the fuel inlet conduit, and an oscillator outlet in fluid communication with the combustion pre-chamber; and
an ignition device operatively coupled to the combustion pre-chamber,
wherein the fluidic oscillator flow path includes a plurality of oscillator conduits fluidly coupled to one another in parallel such that each oscillator conduit of the plurality of oscillator conduits effects fluid communication between the oscillator inlet and the oscillator outlet.

2. The combustion pre-chamber assembly of claim 1, wherein the oscillator outlet is upstream of the combustion pre-chamber.

3. The combustion pre-chamber assembly of claim 1, wherein the plurality of oscillator conduits includes:
a central conduit defined by walls of the body that extend and diverge from the oscillator inlet towards the oscillator outlet, and
a plurality of feedback conduits in fluid communication with an end of the central conduit, the oscillator outlet, and the oscillator inlet,
wherein the central conduit extends along a longitudinal axis of the fluidic oscillator flow path.

4. The combustion pre-chamber assembly of claim 3, wherein each feedback conduit includes:
a first sub-conduit that extends perpendicular to the longitudinal axis of the fluidic oscillator flow path from a respective position between the central conduit and the oscillator outlet,
a second sub-conduit that extends from the first sub-conduit parallel to the longitudinal axis of the fluidic oscillator flow path, and
a third sub-conduit that extends from the second sub-conduit parallel to the first sub-conduit to a respective position between the oscillator inlet and the central conduit.

5. The combustion pre-chamber assembly of claim 4, wherein the plurality of feedback conduits includes two feedback conduits equally spaced in a circumferential direction about the longitudinal axis of the fluidic oscillator flow path.

6. The combustion pre-chamber assembly of claim 4, wherein the plurality of feedback conduits includes four feedback conduits equally spaced in a circumferential direction about the longitudinal axis of the fluidic oscillator flow path.

7. The combustion pre-chamber assembly of claim 3, wherein the longitudinal axis of the fluidic oscillator flow path extends parallel to a longitudinal axis of the combustion pre-chamber assembly.

8. The combustion pre-chamber assembly of claim 3, wherein the longitudinal axis of the fluidic oscillator flow path is positioned at a first angle relative to a longitudinal axis of the combustion pre-chamber assembly in a range between about 25° and about 45°.

9. The combustion pre-chamber assembly of claim 8, wherein the fuel inlet conduit includes an upstream end and a downstream end positioned between the outlet of the fuel inlet conduit and the fluidic oscillator flow path,
wherein an axis of the downstream end extends along the first angle relative to the longitudinal axis of the combustion pre-chamber assembly, and
wherein the downstream end is defined by at least one wall within the body that converges in a direction towards the oscillator inlet.

10. The combustion pre-chamber assembly of claim 9, wherein an axis of the upstream end is parallel to the longitudinal axis of the combustion pre-chamber assembly.

11. The combustion pre-chamber assembly of claim 9, wherein an axis of the upstream end extends at a second angle relative to the longitudinal axis of the combustion pre-chamber assembly that is greater than or equal to the first angle.

12. The combustion pre-chamber assembly of claim 3, wherein the body defines a fluid passageway extending through the body, and
wherein the fluid passageway extends around the fluidic oscillator flow path adjacent the plurality of feedback conduits within the body.

13. The combustion pre-chamber assembly of claim 1, wherein the body includes a body of a tip, a body of a first housing, and a body of a second housing positioned between the tip and the first housing,
wherein the body of the tip defines the plurality of orifices and a first portion of the combustion pre-chamber,
wherein the body of the first housing defines a first housing ignition bore extending to a first opening formed in a first end of the first housing and a first housing injector bore extending to a second opening formed in the first end of the first housing, and
wherein the body of the second housing defines:
a second housing ignition bore in a position corresponding to the first opening of the first housing,
the fuel inlet conduit,
a second portion of the combustion pre-chamber in fluid communication with the first portion of the combustion pre-chamber, and
the fluidic oscillator flow path positioned between the outlet of the fuel inlet conduit and the second portion of the combustion pre-chamber.

14. A reciprocating internal combustion engine, comprising:
a cylinder block;
a cylinder positioned within the cylinder block and defining a main combustion chamber;
a cylinder head attached to the cylinder;
a combustion pre-chamber assembly positioned within the cylinder head in fluid communication with the main combustion chamber;
an intake duct configured to supply a first flow of fuel and a flow of oxidizer to the main combustion chamber; and
a fuel supply system configured to supply a second flow of fuel to the combustion pre-chamber assembly,
wherein the combustion pre-chamber assembly includes a body and an ignition device operatively coupled to combustion pre-chamber defined by the body,
wherein the body of the combustion pre-chamber assembly further defines:
a plurality of orifices that extend through the body and effect fluid communication between the combustion pre-chamber and the main combustion chamber of the reciprocating internal combustion engine,
a fuel inlet conduit, and
a fluidic oscillator flow path with an oscillator inlet in fluid communication with an outlet of the fuel inlet conduit, and with an oscillator outlet in fluid communication with the combustion pre-chamber,
wherein the fluidic oscillator flow path includes a plurality of oscillator conduits fluidly coupled to one another in parallel such that each oscillator conduit of the plurality of oscillator conduits effects fluid communication between the oscillator inlet and the oscillator outlet.

15. The internal combustion engine of claim 14, wherein the plurality of oscillator conduits includes:
a central conduit defined by walls of the body that extend and diverge from the oscillator inlet towards the oscillator outlet, and
a plurality of feedback conduits in fluid communication with an end of the central conduit, the oscillator outlet, and the oscillator inlet,
wherein the central conduit extends along a longitudinal axis of the fluidic oscillator flow path.

16. The internal combustion engine of claim 15, wherein the longitudinal axis of the fluidic oscillator flow path is positioned at a first angle relative to a longitudinal axis of the combustion pre-chamber assembly.

17. The internal combustion engine of claim 15, wherein the cylinder head includes a cylinder head body that defines a main fluid passage and a fluid delivery conduit in fluid communication with the main fluid passage,
wherein the body of the combustion pre-chamber assembly is positioned within the main fluid passage,
wherein the body defines a fluid passageway extending through the body and in fluid communication with the main fluid passage, and
wherein the fluid passageway extends around the fluidic oscillator flow path adjacent to the plurality of feedback conduits.

18. A method for providing an ignition energy to a main combustion chamber of an internal combustion engine via a combustion pre-chamber assembly disposed in fluid communication with the main combustion chamber, the method comprising:
supplying a first flow of fuel and a flow of oxidizer via the main combustion chamber into a combustion pre-chamber defined by the combustion pre-chamber assembly;
supplying a second flow of fuel to an oscillator inlet of a fluidic oscillator flow path including a plurality of oscillator conduits fluidly coupled to one another in parallel such that each oscillator conduit of the plurality of oscillator conduits effects fluid communication between the oscillator inlet and an oscillator outlet;
passively inducing a periodic modulation of the second flow of fuel exiting the oscillator outlet;
forming a mixture of the second flow of fuel, the first flow of fuel, and the flow of oxidizer within the combustion pre-chamber;
supplying the ignition energy to the combustion pre-chamber and igniting the mixture in the combustion pre-chamber to produce combustion products; and
flowing the combustion products from the combustion pre-chamber via a plurality of orifices defined by the combustion pre-chamber to provide the main combustion chamber with the ignition energy.

19. The method according to claim 18, wherein the second flow of fuel exits the oscillator outlet in a waveform that is one of a sine waveform, a sawtooth waveform, and a rectangular waveform.

20. The method according to claim 18, wherein passively inducing the periodic modulation of the second flow of fuel exiting the oscillator includes:
flowing the second flow of fuel upstream of the oscillator outlet along a wall on a first side of the fluidic oscillator flow path and changing a pressure distribution in the fluidic oscillator flow path,
directing a first portion of the second flow of fuel to the oscillator inlet through a feedback conduit of the plurality of oscillator conduits on the first side,
directing the second flow of fuel downstream of the oscillator outlet to a second side of the fluidic oscillator opposite to the first side, and
deflecting the second flow of fuel upstream of the oscillator outlet to flow along a wall on the second side of the fluidic oscillator flow path.
